(19) United States
(12) Patent Application Publication
(10) Pub. No.: US 2026/0135775 A1
(43) Pub. Date: May 14, 2026

(54) CORE NETWORK AND NETWORK NODE OF MOBILE COMMUNICATION NETWORK, AND COMPUTER-READABLE STORAGE MEDIUM

(71) Applicant: KDDI CORPORATION, Tokyo (JP)

(72) Inventors: Souhei ITAHARA, Fujimino-shi (JP); Masaki SUZUKI, Fujimino-shi (JP); Akito SUZUKI, Fujimino-shi (JP); Masayuki KURATA, Fujimino-shi (JP)

(21) Appl. No.: 19/437,459

(22) Filed: Dec. 31, 2025

Related U.S. Application Data
(63) Continuation of application No. PCT/JP2024/007226, filed on Feb. 28, 2024.

(30) Foreign Application Priority Data
Jul. 7, 2023 (JP) 2023-112248

(51) Int. Cl. H04L 41/16

(52) U.S. Cl. CPC H04L 41/16

(57) ABSTRACT

A core network, includes: a storage unit configured to store a plurality of learning models that are to be used for a same intended use but have different levels, the level of the learning model indicating a degree of an amount of information related to learning data included in the learning model; a determination unit configured to, in response to receiving a message requesting a first learning model from a consumer node, determine whether or not the first learning model can be provided, and, if can be provided, determine the level of the first learning model; and a notification unit configured to notify the consumer node of information specifying the first learning model having a first level, if it is determined that the first learning model having the first level can be provided.

### CROSS-REFERENCE TO RELATED APPLICATIONS

This application is a continuation of International Patent Application No. PCT/JP2024/007226 filed on February 28, 2024, which claims priority to and the benefit of Japanese Patent Application No. 2023-112248 filed on July 7, 2023, the entire disclosures of which are incorporated herein by reference.

### BACKGROUND OF THE INVENTION

### Field of the Invention

The present disclosure relates to a core network and a network node of a mobile communication network.

### Description of the Related Art

The 3rd Generation Partnership Project (3GPP) has defined a Network Data Analysis Function (NWDAF) for analyzing the current state of a mobile communication network and estimating its future state. The NWDAF includes at least one of a Model Training Logic Function (MTLF) and an Analysis Logic Function (AnLF). The MTLF generates a learning model (hereinafter simply referred to as a model) by performing machine learning based on learning data collected from each network function (NF), apparatus, and the like in the mobile communication network. The AnLF executes estimation using the model generated by the MTLF. In addition, the 3GPP has also defined an Analysis Data Repository Function (ADRF) that stores the analysis result or estimation result of the NWDAF.

The analysis result or estimation result of the NWDAF may not only be used within an operator of the mobile communication network that operates the NWDAF, but may also be provided to an NF operated by an organization external to the operator for use by that organization. In the following description, the NF that acquires the analysis result, estimation result, or the like of the NWDAF is referred to as an NF service consumer (NFc).

The analysis result or estimation result of the NWDAF may include privacy information (e.g., user location information) about a user who uses the mobile communication network that includes the NWDAF. For this reason, the 3GPP is currently discussing changing the degree of anonymization of data showing analysis results and estimation results depending on the NFc to which the analysis results or estimation results are provided.

Furthermore, a mobile communication network operator may provide the NFc with the model itself generated by the NWDAF (MTLF) operated by that operator.

Here, Nasr, Milad, Reza Shokri, and Amir Houmansadr, “Comprehensive privacy analysis of deep learning”, Proceedings of IEEE Symposium on Security and Privacy, 2018 discloses that a model generated through machine learning includes information about the learning data used to train the model. Therefore, if the learning data includes privacy information, the model generated through machine learning will also include privacy information.

### SUMMARY OF THE INVENTION

For this reason, the 3GPP is currently considering providing models only to NFcs selected in advance by an operator, and not providing models to other NFcs. Accordingly, the operator has only two options, which are to provide the model to the NFc or not.

According to the present disclosure, a core network of a mobile communication network, includes: a storage unit configured to store a plurality of learning models that are generated based on learning data and are to be used for a same intended use but have different levels, the level of the learning model indicating a degree of an amount of information related to the learning data included in the learning model; a determination unit configured to, in response to receiving a message requesting a first learning model for a first intended use from a consumer node, determine whether or not the first learning model can be provided to the consumer node, and, if the first learning model can be provided to the consumer node, determine the level of the first learning model that can be provided to the consumer node; and a notification unit configured to notify the consumer node of information specifying the first learning model having a first level, if it is determined that the first learning model having the first level can be provided to the consumer node.

According to the present disclosure, there can be three or more options for providing the model.

Other features and advantages of the present invention will be apparent from the following description taken in conjunction with the accompanying drawings. Note that the same reference numerals denote the same or like components throughout the accompanying drawings.

### BRIEF DESCRIPTION OF THE DRAWINGS

FIG. 1 is a sequence diagram showing an example of model generation processing and provision processing according to the background art;

FIG. 2 is a diagram showing determination information stored in the NRF in the sequence of FIG. 1;

FIG. 3 is a diagram showing an example of a configuration of a system according to an embodiment;

FIG. 4 is a sequence diagram showing an example of model generation processing according to an embodiment;

FIG. 5A is a diagram showing an example of model information according to an embodiment;

FIG. 5B is a diagram showing an example of information stored in an ADRF, according to an embodiment;

FIG. 5C is a diagram showing an example of determination information according to an embodiment;

FIG. 6 is a sequence diagram showing an example of model provision processing according to an embodiment;

FIG. 7 is a functional block diagram of a core network according to an embodiment; and

FIG. 8 is a functional block diagram of a network node according to an embodiment.

### DESCRIPTION OF THE EMBODIMENTS

Hereinafter, embodiments will be described in detail with reference to the accompanying drawings. It should be noted that the following embodiments do not limit the invention according to the claims, and not all of the combinations of features described in the embodiments are necessarily essential to the invention. Two or more of the features described in the embodiments may be combined as appropriate. In addition, the same or similar components are denoted by the same reference numerals, and redundant description is omitted.

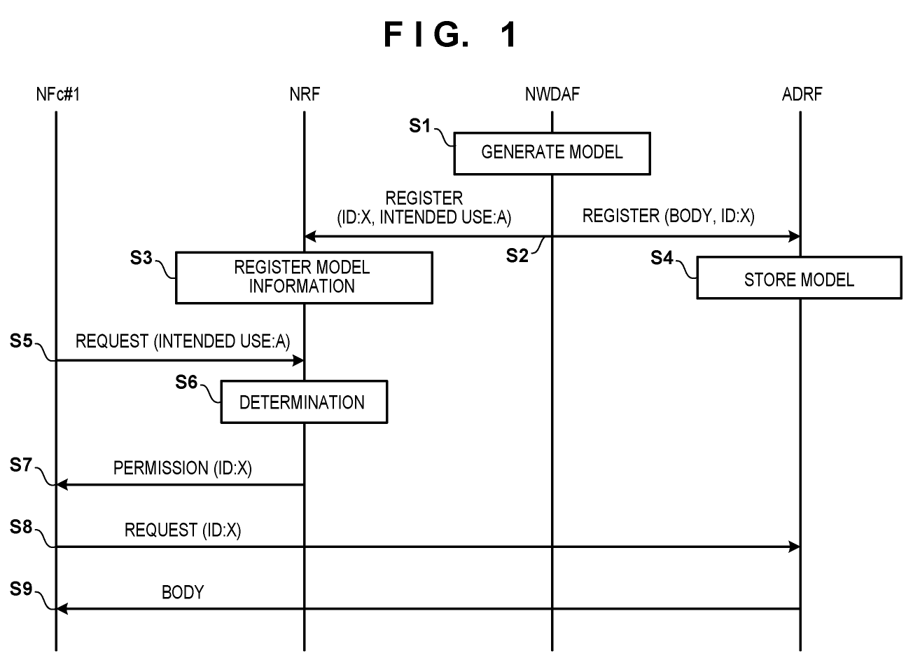

Before describing the embodiments, an example of the current model generation processing and provision processing will be described with reference to FIG. 1. In step S1, an NWDAF generates a model based on learning data. Here, the intended use of the model generated in step S1 is “A” and its identifier (ID) is “X”. In step S2, the NWDAF notifies an ADRF of the body of the model generated in step S1 and its identifier X, and also notifies a Network Repository Function (NRF) of the identifier X and the intended use A of the model generated in step S1. In step S3, the NRF registers the relationship between the identifier X of the model and the intended use A of the model in the model information. In addition, the ADRF stores the model body in association with its identifier X in step S4.

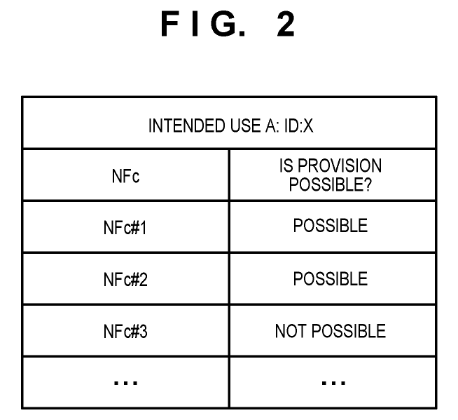

In step S5, an NFc #1, which is one of the NFcs, transmits a request message requesting a model for the intended use A to the NRF. In step S6, the NRF determines whether or not the model for the intended use A can be provided to the NFc #1 based on preset determination information. FIG. 2 shows an example of the determination information. FIG. 2 shows that a model for the intended use “A” identified by the identifier X can be provided to the NFc #1 and the NFc #2, but cannot be provided to the NFc #3. Accordingly, the NRF determines in step S6 that the model can be provided in accordance with the determination information in FIG. 2, and transmits a permission message including the identifier X to the NFc #1 in step S7. In step S8, the NFc #1 transmits a request message for the model body including the identifier X to the ADRF. In response to the request message, the ADRF transmits the model body having the identifier X to the NFc #1 in step S9. Note that, for example, if the NFc #3 requests a model for the intended use A, the NRF determines in step S6 that it cannot provide the model based on the determination information in FIG. 2, and notifies the NFc #3 that permission is not granted in step S7.

As is clear from the determination information in FIG. 2, the operator of the mobile communication network has two options, that is, it determines whether or not to provide a model for each NFc.

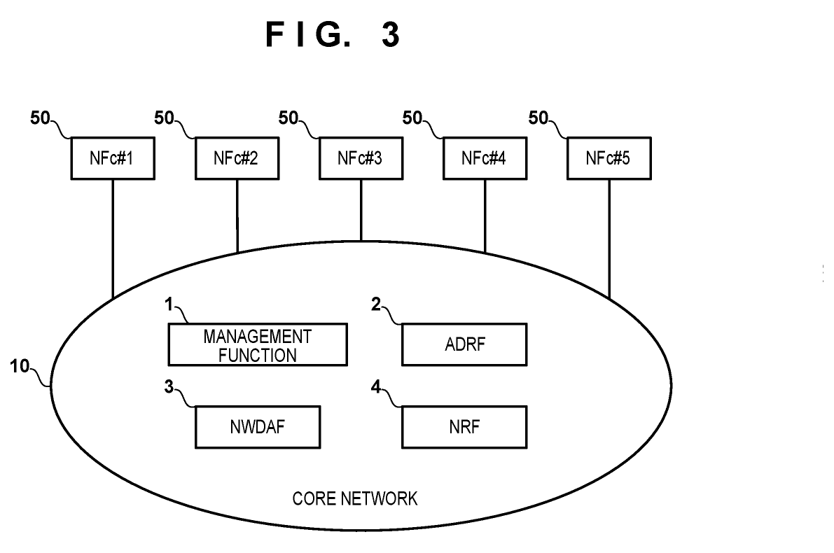

The present embodiment will be described below. FIG. 3 is a diagram showing the system configuration according to this embodiment. The core network 10 of the mobile communication network includes a management function 1, an ADRF 2, an NWDAF 3, and an NRF 4. Note that in the following description, the operator of the mobile communication network including the core network 10 will be referred to as an “operator of interest”.

The NWDAF 3 has a function of performing machine learning based on learning data to generate a model. Note that the NWDAF 3 of this embodiment has a function of generating a plurality of pieces of learning data for the same intended use but having different levels based on learning data. The level indicates the degree of the amount of information (and therefore the amount of privacy information) about the learning data included in the model. For example, the NWDAF 3 can generate models having various levels for the same intended use based on differential privacy, as disclosed in Abadi, Martin, et. al., “Deep learning with differential privacy”, Proceedings of ACM SIGSAC conference on computer and communications security, 2016. According to Abadi, Martin, et. al., “Deep learning with differential privacy”, Proceedings of ACM SIGSAC conference on computer and communications security, 2016, the amount of privacy information included in the model is controlled by two parameters ε and δ. Note that, in general, the less information about the learning data included in a model there is, the more the performance of the model, for example, estimation performance, deteriorates.

The ADRF 2 stores the model generated by the NWDAF 3. The NRF 4 functions as a gateway for an NFc 50. The NFc50 is an NF operated by an external organization different from the operator of interest, and is also referred to as a consumer node. Note that external organizations may include not only operators of mobile communication networks other than the operator of interest, but also operators of other types of networks such as Internet service providers (ISPs), and companies and organizations that use services of mobile communication networks operated by the operator of interest.

The NFc 50 has a function of acquiring the model generated by the NWDAF 3. Note that although five NFcs 50 are shown in FIG. 3, the number of NFcs 50 may be any number greater than or equal to one. In the following description, when it is necessary to distinguish between the five NFcs 50, they will be referred to as an NFc #1 to an NFc #5, as shown in FIG. 3. The management function 1 controls the provision of the models generated by the NWDAF 3 to the NFc #1 to the NFc #5.

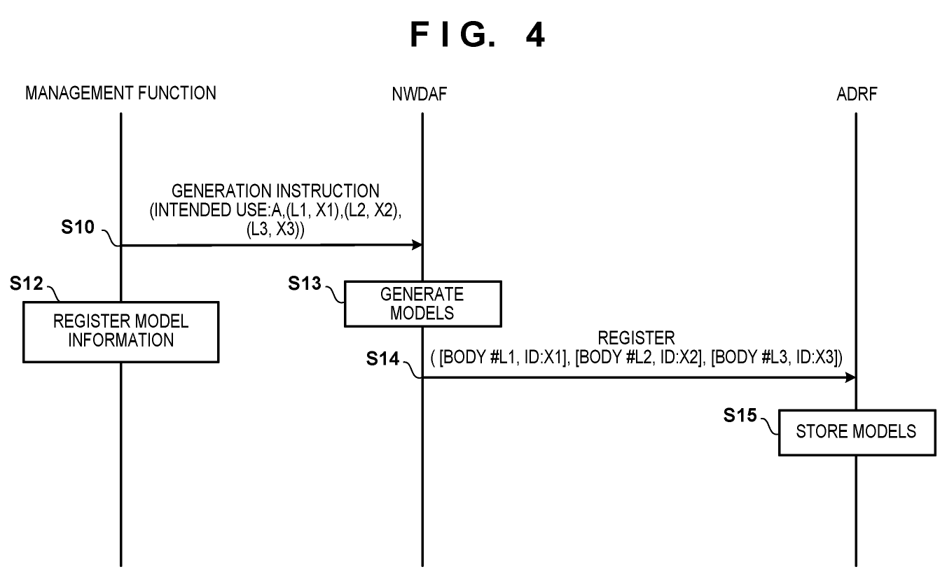

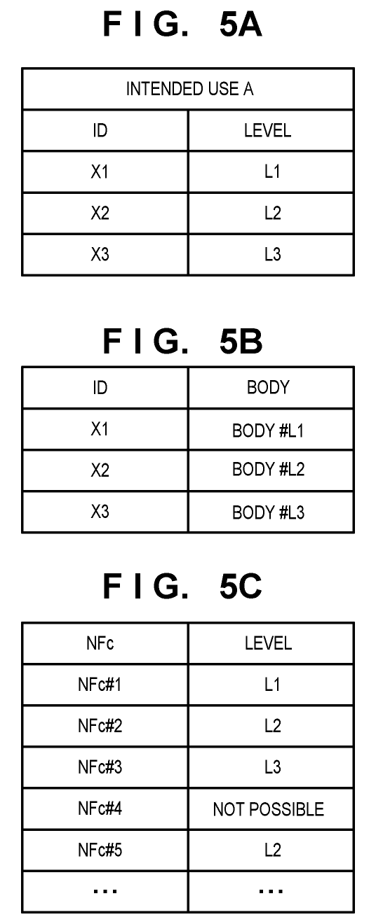

FIG. 4 shows a sequence of model generation. In step S10, the management function 1 instructs the NWDAF 3 to generate a model for the intended use A in accordance with the input from the operator of interest. At this time, the management function 1 instructs the NWDAF 3 to generate a plurality of models having different levels according to the input from the operator of interest. In FIG. 4, the generation of three models having levels L1 to L3 is instructed. In this example, the larger the level number is, the less privacy information is included. Note that, for example, the level L1 can also be a model generated through machine learning that does not take into consideration the amount of privacy information included in the model. In this example, the management function 1 also notifies the NWDAF 3 of the identifier of the model having each level. According to FIG. 4, the identifiers of the models having the levels L1, L2, and L3 are X1, X2, and X3. In step S12, the management function 1 registers the model information. Note that registering the model information means storing the model information in the management function 1, or storing the model information in another NF that the management function 1 can access. As shown in FIG. 5A, the model information indicates the relationship between the identifiers of the three models generated for the intended use A and their levels.

In step S13, the NWDAF 3 generates three models for the intended use A in response to the model generation instruction from the management function 1. In the following description, a model body having level Ln (n is an integer from 1 to 3) will be referred to as body #Ln. In step S14, the NWDAF 3 transmits the three generated model bodies and their identifier information to the ADRF 2. In step S15, the ADRF 2 stores the three model bodies in association with their identifiers, as shown in FIG. 5B.

Note that in the example of FIG. 4, models having three different levels are generated, but the number of levels can be any number greater than or equal to two. Furthermore, in the example of FIG. 4, the management function 1 notifies the NWDAF 3 of the identifier of the model generated by the management function 1, but the NWDAF 3 may also be configured to determine the identifier of the model. In this case, in step S10, the management function 1 notifies the NWDAF 3 of the intended use of the model to be generated and its level, and the NWDAF 3 determines the identifier of the model having each level and notifies the management function 1 of the identifier. Then, the management function 1 registers the model information based on the identifier of the model having each level notified by the NWDAF 3.

Furthermore, in the example of FIG. 4, the NWDAF 3 generates a model based on a generation instruction from the management function 1, but the trigger for generating a model is not limited to a generation instruction from the management function 1, such as, for example, the operator of interest directly inputting a model generation instruction to the NWDAF 3. In this case, the NWDAF 3 notifies the management function 1 of the intended use, level, and identifier of the generated model.

In addition, the management function 1 or other NFs accessible by the management function 1 stores the determination information shown in FIG. 5C in advance. The determination information is information indicating whether or not a model can be provided for each NFc 50, and, if a model can be provided, indicating the level of the model that can be provided. FIG. 5C shows that the NFc #1 can be provided with a model having the level L1, the NFc #2 and the NFc #5 can be provided with a model having the level L2, the NFc #3 can be provided with a model having the level L3, and the NFc #4 cannot be provided with a model. Note that the determination information can also indicate only the level at which a model can be provided for the NFc 50. In this case, the NFc 50 that is not included in the determination information is treated as being unable to be provided with a model.

The determination information can be determined in advance based on, for example, an agreement between the operator of interest and the organization that operates each NFc 50. Alternatively, the determination information can be determined solely by the operator of interest.

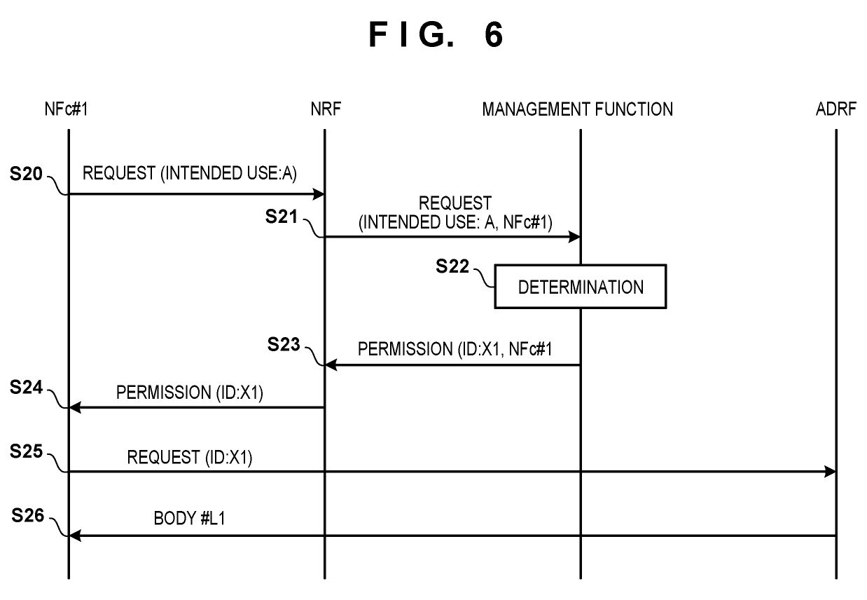

FIG. 6 is a sequence diagram of model provision processing. In step S20, the NFc #1 transmits a request message requesting a model for the intended use A, to the NRF 4. In step S21, the NRF 4 transmits a request message indicating that the NFc #1 is requesting a model for the intended use A, to the management function 1.

In step S22, the management function 1 determines whether or not a model for the intended use A can be provided to the NFc #1, and, if it can be provided, determines the level at which it can be provided. Based on the determination information in FIG. 5C, a model having the level L1 can be provided to the NFc #1. Accordingly, the management function 1 notifies the NRF 4 of a permission message in step S23. The permission message includes information indicating the identifier X1 of the model having the level L1 for the intended use A, and information specifying the NFc #1, which is to be granted permission. Note that the management function 1 determines the identifier X1 of the model having the level L1 for the intended use A by referring to the model information.

In step S24, the NRF 4 transmits a permission message to the NFc #1. The permission message includes information indicating the identifier X1 of the model having the level L1 for the intended use A. In step S25, the NFc #1 transmits a request message for the model body including information indicating the identifier X1 to the ADRF 2. In response to the request message, the ADRF 2 transmits the body #L1 of the model with the identifier X1 to the NFc #1 in step S26.

Note that, for example, if the NFc #2 requests a model for the intended use A, the management function 1 determines that a model having the level L2 can be provided based on the determination information in FIG. 5C, and transmits a permission message including information indicating the identifier X2 in step S23. In addition, if the NFc #4 requests a model for the intended use A, the management function 1 determines that the model cannot be provided based on the determination information in FIG. 5C, and transmits a message indicating that permission cannot be granted in step S23. Note that if a model cannot be provided, instead of transmitting a message indicating that permission is not granted to the requesting NFc 50, it is also possible to configure the system such that no message is transmitted to the requesting NFc 50.

In the sequence of FIG. 6, the determination result in step S22 by the management function 1 is notified to the NFc 50 via the NRF 4, but the management function 1 may be configured to notify the NFc 50 directly. In addition, the determination information and model information may be stored in the NRF 4, or the NRF 4 may be configured to be able to access the determination information and model information stored in the management function 1 or another NF, and the NRF 4 may determine whether or not a model can be provided, and, if it can be provided, determine its level.

In addition, although the determination information in FIG. 5C is used in common for all intended uses regardless of the intended use of the model, it is also possible to configure the determination information to be provided for each intended use of the model. In this case, for example, a model for the intended use A having the level L1 is provided to the NFc #1, but regarding a model for an intended use B, no model is provided to the NFc #1, or a model having a level different from the level L1 is provided.

With the above configuration, instead of selecting one of two options, namely to provide or not provide a model to the NFc 50, it is now possible to select from three or more options. In other words, it is possible to diversify model provision options to three or more options.

Note that each of the management function 1, the ADRF 2, the NWDAF 3, and the NRF 4 shown in FIG. 3 can be implemented as a single apparatus, or as a plurality of apparatuses that can communicate with each other. In addition, two or more functions out of the management function 1, the ADRF 2, the NWDAF 3, and the NRF 4 can be implemented as a single apparatus.

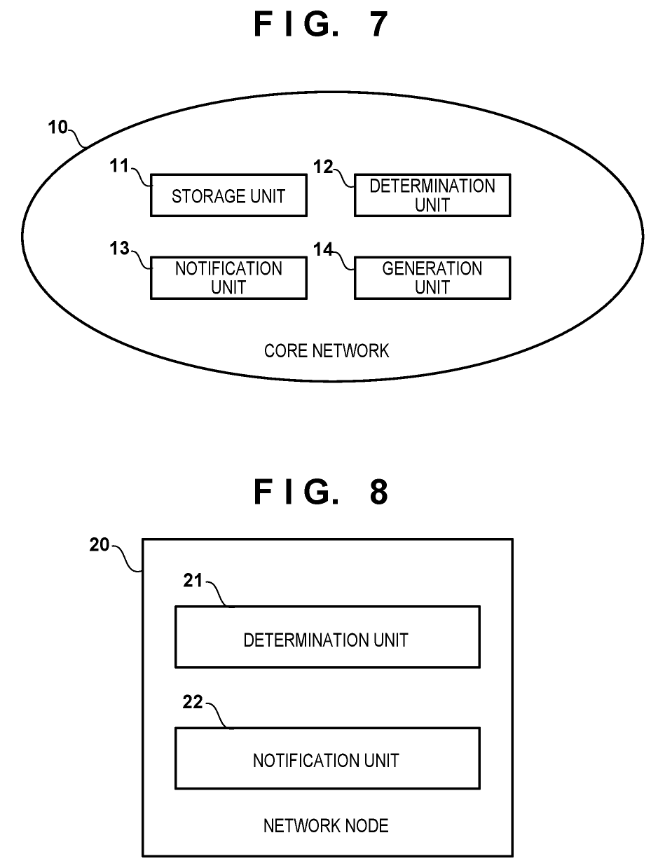

FIG. 7 is a functional block diagram of the core network 10 according to the embodiment. The generation unit 14 performs processing for generating a plurality of models that are used for the same intended use but have different levels based on the learning data and storing the models in the storage unit 11. The generation unit 14 corresponds to, for example, the NWDAF 3 (MTLF) in FIG. 3. The storage unit 11 corresponds to the ADRF 2 in FIG. 3.

In response to receiving, from the NFc 50, a message requesting a first learning model for a first intended use, the determination unit 12 determines whether or not a first learning model can be provided to the NFc 50, and, if it can be provided, determines the level of the first learning model that can be provided. The determination can be made by referring to the model information and the determination information. The determination unit 12 corresponds to the management function 1 in FIG. 3. Note that, as described above, when the processing of step S22 in FIG. 6 is performed by the NRF 4, the determination unit 12 corresponds to the NRF 4.

If the determination unit 12 determines that the first learning model can be provided to the NFc 50, the notification unit 13 notifies the NFc 50 of information specifying the first learning model having a level that can be provided, for example, an identifier. In addition, if the determination unit 12 determines that the first learning model cannot be provided to the NFc 50, the notification unit 13 explicitly indicates that the first learning model cannot be provided to the NFc 50 by transmitting a message, or implicitly indicates that the first learning model cannot be provided to the NFc 50 by not transmitting a response. In the sequence of FIG. 6, the notification unit 13 corresponds to the management function 1 and the NRF 4. Note that when the management function 1 directly notifies the NFc 50 of the determination result, the notification unit 13 corresponds to the management function 1, and when the processing of step S22 in FIG. 6 is performed, the notification unit 13 corresponds to the NRF 4.

FIG. 8 is a configuration diagram of a network node 20 of a mobile communication network according to this embodiment. The network node 20 may be, for example, an apparatus of the core network 10. The network node 20 may be, for example, an apparatus that implements the management function 1 of FIG. 3, an apparatus that implements the NRF 4, or an apparatus that implements both the management function 1 and the NRF 4.

In response to receiving a message from the NFc 50 requesting the first learning model for a first intended use, the determination unit 21 determines whether the first learning model can be provided to the NFc50, and, if it can be provided, determines the level of the first learning model that can be provided. The determination can be made by referring to the model information and the determination information. Note that the model information and the determination information can be stored in the determination unit 12. Alternatively, one or both of the model information and the determination information may be stored in an apparatus other than the network node 20. In this case, the determination unit 12 makes a determination by referring to information stored in the other apparatus.

The notification unit 22 performs processing for notifying the NFc 50 of the determination result achieved by the determination unit 21. Note that if the determination unit 21 determines that the first learning model can be provided to the NFc 50, the determination result includes information specifying the first learning model having a level that can be provided, such as an identifier. The processing for notifying the NFc 50 of the determination result may be, for example, processing for directly transmitting a message indicating the determination result to the NFc 50. Alternatively, the processing for notifying the NFc 50 of the determination result may be processing for notifying another apparatus of the determination result and notifying the NFc 50 of the determination result via the other apparatus.

In addition, the present disclosure provides a computer program that, when executed by one or more processors of an apparatus having the one or more processors, causes the apparatus to operate as the network node 20, and a non-transitory computer-readable storage medium having the computer program stored thereon. Furthermore, the present disclosure provides a method to be executed by a network node 20, a computer program for causing an apparatus having one or more processors to execute the method, and a non-transitory computer-readable storage medium having the computer program stored thereon.

The invention is not limited to the foregoing embodiments, and various variations/changes are possible within the spirit of the invention.

What is claimed is:

1. A core network of a mobile communication network, comprising:
a storage unit configured to store a plurality of learning models that are generated based on learning data and are to be used for a same intended use but have different levels, the level of the learning model indicating a degree of an amount of information related to the learning data included in the learning model;
a determination unit configured to, in response to receiving a message requesting a first learning model for a first intended use from a consumer node, determine whether or not the first learning model can be provided to the consumer node, and, if the first learning model can be provided to the consumer node, determine the level of the first learning model that can be provided to the consumer node; and
a notification unit configured to notify the consumer node of information specifying the first learning model having a first level, if it is determined that the first learning model having the first level can be provided to the consumer node.

2. The core network according to claim 1,
wherein the notification unit is further configured to, if the determination unit determines that the first learning model cannot be provided to the consumer node, notify the consumer node that the first learning model cannot be provided, or not transmit a response to the message to the consumer node.

3. The core network according to claim 1,
wherein the determination unit is further configured to determine, based on determination information indicating the level of the learning model that can be provided to the consumer node, whether or not the first learning model can be provided to the consumer node, and, if the first learning model can be provided to the consumer node, determine the level of the first learning model that can be provided to the consumer node.

4. The core network according to claim 3,
wherein the determination information is information that is to be used in common regardless of the intended use of the learning model.

5. The core network according to claim 3,
wherein the determination information is provided for each intended use of the learning model, and
the determination unit is further configured to determine, based on the determination information of the first intended use, whether or not the first learning model can be provided to the consumer node, and, if the first learning model can be provided to the consumer node, determine the level of the first learning model that can be provided to the consumer node.

6. The core network according to claim 1, further comprising
a generation unit configured to perform processing for generating the plurality of learning models to be used for the same intended use but having different levels based on the learning data, and storing the learning models in the storage unit.

7. The core network according to claim 1,
wherein the consumer node is a network node operated by an organization different from an operator of the core network.

8. A network node of a mobile communication network, the mobile communication network storing a plurality of learning models that are generated based on learning data and are to be used for a same intended use but have different levels, and the levels of the learning models indicating a degree of an amount of information related to the learning data included in the learning models, the network node comprising:
a determination unit configured to, in response to receiving a message requesting a first learning model for a first intended use from a consumer node, determine whether or not the first learning model can be provided to the consumer node, and, if the first learning model can be provided to the consumer node, determine the level of the first learning model that can be provided to the consumer node; and
a notification unit configured to, if it is determined that the first learning model having a first level can be provided to the consumer node, perform processing for notifying the consumer node of information specifying the first learning model having the first level.

9. The network node according to claim 8,
wherein the determination unit is further configured to, based on determination information indicating the level of the learning model that can be provided to the consumer node, determine whether or not the first learning model can be provided to the consumer node, and, if the first learning model can be provided to the consumer node, determine the level of the first learning model that can be provided to the consumer node.

10. A non-transitory computer readable storage medium storing a computer program which, when executed by one or more processors of an apparatus, causes the apparatus to function as a network node according to claim 8.
